(19) United States
(12) Patent Application Publication
(10) Pub. No.: US 2024/0359161 A1
(43) Pub. Date: Oct. 31, 2024

(54) PARTICLES FOR AFFINITY CHROMATOGRAPHY AND METHODS OF PRODUCTION THEREOF

(71) Applicant: Waters Technologies Corporation, Milford, MA (US)

(72) Inventors: Kevin Wyndham, Worcester, MA (US); Beatrice Muriithi, Attleboro, MA (US); Oksana Tchoul, Winchester, MA (US); Yeliz Tunc Sarisozen, Westford, MA (US); MingCheng Xu, Lexington, MA (US); Matthew Lauber, North Smithfield, RI (US)

(73) Assignee: Waters Technologies Corporation, Milford, MA (US)

(21) Appl. No.: 18/647,811

(22) Filed: Apr. 26, 2024

Related U.S. Application Data
(60) Provisional application No. 63/555,295, filed on Feb. 19, 2024.
(60) Provisional application No. 63/499,087, filed on Apr. 28, 2023.

(51) Int. Cl. B01J 20/289; B01D 15/22; B01D 15/38; B01J 20/26; B01J 20/28; B01J 20/32

(52) U.S. Cl. CPC B01J 20/289; B01D 15/22; B01D 15/3809; B01J 20/261; B01J 20/28004; B01J 20/28016; B01J 20/321; B01J 20/3219; B01J 20/3274

(57) ABSTRACT

The present disclosure is directed to nonporous polymer particles having an average particle size of 1 to 10 micrometers and being functionalized with streptavidin. The streptavidin functionalized particles of the present disclosure can be bound to biotinylated antibodies, biotinylated antigen-binding fragments thereof, or biotinylated oligonucleotides to create customizable affinity chromatography columns. That is, the functionalized nonporous polymer particles can be packed in a stainless steel, titanium, or other metal or metal alloy column for affinity high pressure liquid chromatography (HPLC).

### CROSS-REFERENCED TO RELATED APPLICATIONS

This application claims the benefit of U.S. Provisional Application No. 63/499,087, filed on Apr. 28, 2023, and U.S. Provisional Application No. 63/555,295, filed on Feb. 19, 2024, the entireties of which are incorporated herein by reference.

### FIELD OF THE TECHNOLOGY

The present technology is directed to affinity capture materials. More particularly, the present technology is directed to chromatographic columns with nonporous particles for use in affinity chromatography.

### BACKGROUND

Chromatography is a separation technique with broad utility across industries, including the pharmaceutical, biotechnology, and chemical industries. Chromatography involves two phases: a stationary phase and a mobile phase. Typically, the stationary phase comprises a porous or nonporous particles that are loaded into a column. The mobile phase then carries a sample through the stationary phase column. One particular application of chromatography, affinity chromatography, utilizes functionalized particles in the stationary phase. The underlying principle behind affinity chromatography is that compounds, or analytes, within a sample will have differential affinities to the functional group on the particle. These differences permit the separation, isolation, and concentration of particular analytes from complex, heterogeneous samples.

Samples generated from laboratory processes (e.g., fermentation), biological sources (e.g., blood), and environmental sources (e.g., wastewater) contain an unpredictable number and composition of analytes. In many instances, only a particular analyte from a given sample is of interest. But due to the complexity of the sample, the analyte of interest can be at such a low concentration, or in the presence of enough impurities, that it is undetectable using standard analytical methods. As such, it is highly desirable to be able to isolate an analyte of interest that is both substantially pure and at high enough concentrations that permit downstream analytical assays.

Current methods of affinity chromatography are hindered by columns that are low throughput and high cost, and often result in loss of analyte(s) of interest due to non-specific binding and/or poor analyte retention. Other types of immunoassays, such as for example, ELISA technology, can be complex, time consuming and highly variable. Therefore, a need in the art exists for affinity chromatography columns that are highly efficient and enable robust separation, collection, and concentration of analytes of interest.

### SUMMARY

In general, the present technology is directed to a plurality of particles used in affinity chromatography. More specifically, the present technology is directed to a chromatographic column containing a plurality of particles having an average particle size of less than 10 microns, wherein an outer hydrophilic surface of each of the particles is connected to an affinity attachment group, such as streptavidin, which serves as the binding site for a biotinylated affinity group. As a result, the chromatographic columns of the present technology can be used in affinity chromatography.

A number of biotinylated affinity groups are suitable for use with the present technology, thereby generating a chromatography column. Examples of biotinylated affinity groups include, but are not limited to, biotinylated monoclonal antibodies, biotinylated polyclonal antibodies that bind to host cell proteins, and biotinylated oligonucleotides.

In some embodiments, the affinity group is a biotinylated anti-IgG antibody. In some embodiments, the affinity group is a biotinylated polyclonal antibody (or a population of biotinylated polyclonal antibodies) that bind to host cell proteins (a biotinylated anti-HCP antibody).

There are many ways to amplify DNA/RNA using PCR, qPCR, dPCR. These methods however do not recognize heterogeneity. In addition, these methods tend to amplify trace DNA/RNA outside of the targeted analyte. Next-generation Sequencing (NGS) methods can do a better job with heterogeneity but require expensive libraries to complete the analysis. The present technology is directed to a solution that can measure real levels of DNA/RNA analytes used in therapies, as well as any molecular heterogeneity within a short period of time (e.g., <20 minutes, e.g., 10 minutes). The use of ultra-performance streptavidin particles with biotinylated hybridizable sequences for DNA/RNA targets allows for fast separations. The use of advanced detectors (including MS) allows for improved characterization of heterogeneity.

In one aspect, the present technology is directed to a chromatographic column. The chromatographic column including a column body formed of a metal or metal alloy and housing a plurality of particles. Each particle of the plurality of particles comprising a nonporous polymer core, a hydrophilic surface on an outer layer of the nonporous polymer core; and one or more molecules of streptavidin conjugated to the hydrophilic surface. The plurality of particles has an average particle size between 1.0 micrometers and 10 micrometers (e.g., between 1.5 micrometers and 8 micrometers, for example about 3.5 micrometers).

Other embodiments of the technology are as follows. In some embodiments, the nonporous polymer core has a gradient composition. In some embodiments, the nonporous polymer core comprises divinylbenzene (80) and polystyrene. In some embodiments, the hydrophilic surface is selected from the group consisting of: (3-glycidyloxypropyl) trimethoxysilane, (3-glycidyloxypropyl)triethoxysilane, polyacrylate, glycidol, glyceroltriglycidyl ether, and poly(methyl acrylate). In some embodiments the one or more molecules of streptavidin are conjugated to the hydrophilic surface of the particle via an epoxy linker.

In some embodiments, the epoxy linker has a formula:

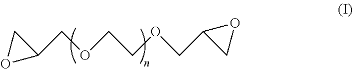

wherein n is between 1-12. In some embodiments, n is 1, 4 or 9. In some embodiments, n is 1.

In some embodiments, the average particle size is between 2 to 5 micrometers. In one embodiment, the average particle size is 3.5 micrometers. In one embodiment, the average particle size is 7 micrometers. In yet other embodiments, the one or more molecules of streptavidin are bound to a biotinylated oligonucleotide, or a biotinylated antibody or biotinylated antigen-binding fragment thereof.

In some embodiments, the column body of the chromatographic column has an internal diameter of 1 mm to 2.1 mm. In some embodiments, the column body of the chromatographic column has a length of 15 mm to 50 mm. In some embodiments, at least a portion of an interior surface of the column body is coated with an alkylsilyl material. In some embodiments, the chromatographic column further comprises frits within the column body, wherein the frits are coated with the alkylsilyl material. In some embodiments, the alkylsilyl material is a hydrophilic, non-ionic layer of polyethylene glycol silane.

In one aspect, disclosed herein is a chromatographic device comprising the chromatographic column, a column injector positioned upstream of the chromatographic column, and tubing in fluidic connection with and located downstream of the chromatographic column, wherein a portion of an internal surface of the column injector and a portion of an internal surface of the tubing are coated with an alkylsilyl material.

### BRIEF DESCRIPTION OF THE DRAWINGS

The technology will be more fully understood from the following detailed description taken in conjunction with the accompanying drawings, in which:

FIG. 1A is a cross-sectional illustration of a particle prior to attachment of streptavidin in accordance with an embodiment of the technology.

FIG. 1B is a cross-sectional illustration of the particle of FIG. 1A after attachment of streptavidin in accordance with an embodiment of the technology.

FIG. 2A is a perspective view of a chromatographic column packed with a plurality of particles (i.e., particles of FIG. 1B) having a cut out section (220) to illustrate an interior portion of the chromatographic column.

FIG. 2B is a cross-sectional view of the chromatographic column of FIG. 2A taken along line BB.

FIG. 3 is a schematic illustrating a method of on-column loading of an affinity group to the plurality of particles packed in the chromatographic column of FIG. 2A.

FIG. 4 demonstrates the ability for a biotinylated, anti-insulin antibody to bind to a column containing streptavidin-functionalized particles.

FIG. 5A demonstrates the ability for biotinylated, anti-AAV antibody to bind to a column containing streptavidin-functionalized particles in accordance with the present technology.

FIG. 5B-5C demonstrate anti-AAV antibody binding capabilities of two different columns containing streptavidin-functionalized particles in accordance with the present technology.

FIG. 6 demonstrates the ability for a 5′-biotinylated oligonucleotide (dT₂₅) to bind to a column containing streptavidin-functionalized particles in accordance with the present technology.

FIG. 7A demonstrates streptavidin leaching from a column of the present technology after an applied wash method.

FIG. 7B demonstrates streptavidin leaching from a column of the present using a different wash method.

FIG. 8 demonstrates the ability for a biotinylated anti-dsRNA antibody to bind to a column containing streptavidin-functionalized particles.

FIG. 9A demonstrates the ability for a biotinylated anti-insulin antibody to bind to a column containing streptavidin-functionalized particles.

FIG. 9B show the effect of biotin endcapping on an affinity chromatographic column of the present technology.

FIG. 10 demonstrates the ability for biotinylated anti-HCP polyclonal antibodies to bind to a column containing streptavidin-functionalized particles.

### DETAILED DESCRIPTION

In order that the technology may be more readily understood, certain terms are first defined. In addition, it should be noted that whenever a value or range of values of a parameter are recited, it is intended that values and ranges intermediate to the recited values are also part of this disclosure. The word “about” if not otherwise defined means±5%. It is also to be noted that as used herein and in the claims, the singular forms “a,” “and” and “the” include plural references unless the context clearly dictates otherwise.

### Definitions

The term “nonporous” or “nonporous core” as used herein, refers to a material or a material region (e.g., the core) that has a pore volume that is less than 0.1 cc/g. Preferably, nonporous polymer cores have a pore volume that is less than 0.10 cc/g (e.g., 0.05 cc/g), and preferably less than 0.02 cc/g, in some embodiments. Pore volume is determined using methods known in the art based on multipoint nitrogen sorption experiments (Micromeritics ASAP 2400; Micromeritics Instruments Inc., Norcross, GA).

The term “rigid particle,” as used herein, refers to the strength of the particle to withstand applied pressures under flow conditions. A rigid particle appears visually undamaged (i.e., maintains the same form factor without breaking, crushing, or alteration) in a scanning electron microscope image after exposure to pressures of 3,500 psi, wherein less than 10% of the observed particles are visually damaged. In addition, particles in a packed bed that are broken or deformed result in reduced flow and increased pressure as one would predict using the Kozeny-Carmen equation. Broken or deformed particles in a packed bed can increase pressure beyond levels suitable for use in HPLC or UHPLC.

The term “conjugated,” as used herein, refers to the linkage of two molecules formed by the chemical bonding of a reactive functional group of one molecule, such as streptavidin, with an appropriately reactive functional group of another molecule, such as an epoxide.

The term “conjugate,” as used herein, refers to a compound formed by the chemical bonding of a reactive functional group of one molecule, such as streptavidin, with an appropriately reactive functional group of another molecule, such as an epoxide. An example of suitably reactive functional groups is a nucleophile/electrophile pair. For instance, the nucleophile may be an amine group from an amino acid of streptavidin, and the electrophile is an epoxide.

The term “antibody,” as used herein refers to an immunoglobin molecule that specifically binds to, or is immunologically reactive with, a particular antigen. This includes polyclonal, monoclonal, genetically engineering, and otherwise modified forms of antibodies, including but not limited to chimeric antibodies, camelids, monobodies, humanized antibodies, heteroconjugate antibodies (e.g., bi-, tri-, and quad-specific antibodies, diabodies), and antigen-binding fragments of antibodies, including, for example, Fab′, F(ab′)2, Fab, Fv, and scFv fragments. Unless otherwise indicated, the term “monoclonal antibody” is meant to include both intact molecules as well as antibody fragments that are capable of specifically binding to a target protein. As used herein, the Fab and F(ab′)2 fragments refer to antibody fragments that lack the Fc portion of an intact antibody.

The term “antigen-binding fragment,” as used herein refers to one or more fragments of an antibody that retain the ability to specifically bind to a target antigen. The antigen-binding function of an antibody can be performed by fragments of a full-length antibody. The antibody fragments can be, for example, a Fab, F(ab′)2, scFv, a camelid, an affibody, a nanobody, an aptamer, or a domain antibody.

As used herein, the term “polyclonal antibody” refers to an antibody or a population of antibodies that has specificity to one or more antigens (such as, e.g., host cell proteins from a host cell line). A population of polyclonal antibodies recognize one or more distinct epitopes of the one or more antigens.

Unless defined otherwise, all technical and scientific terms used herein have the same meaning as commonly understood by one of ordinary skill in the art to which this disclosure belongs.

### Materials

The present technology is directed to materials, columns, and devices used in affinity chromatography. In particular, the present technology is directed to materials for use in a high performance liquid chromatography (HPLC) system or ultra-high performance liquid chromatography (UHPLC) system and are tailored to allow for affinity capture at the high pressures and flow conditions associated with HPLC and/or UHPLC.

In the present technology, a plurality of particles is housed within a chromatographic column. Along with other components, it is these particles that have been designed to provide on-column affinity capture at the high pressures and flow rates associated with HPLC and UHPLC systems.

### Particles

To provide stability and the surface area for affinity capture, the particles of the present technology are nonporous. The nonporous particles provide the appropriate surface area for the attachment or coverage with one or more affinity binding groups. In some embodiments, each particle within the plurality of particles to be packed into a column may be highly spherical and have a smooth surface. In some embodiments, each particle within the plurality of particles to be packed into a column may be highly spherical and have a bumpy convex surface. Such materials have surface areas (measured in m²/g) that are close to their theoretical values. The theoretical surface area for a nonporous smooth sphere is equal to 6/{particle diameter×particle density}. For example, 1 micron polymer particles with a density of approximately 1 g/mL has a theoretical surface area of 6 m²/g, a 3.5 micron polymer particle with the same density has a theoretical surface area of 1.7 m²/g, and a 7 micrometer polymer particle with same density has a theoretical surface area of 0.9 m²/g.

Without wishing to be bound by theory, it is believed that the use of nonporous spheres is advantageous as it improves the kinetics of binding and elution of affinity binding groups attached to the surface of the sphere (having either a smooth or bumpy with convex surfaces). It is believed that the form factor of a nonporous sphere shuts down diffusion kinetics into pores of the particles.

The particles are nonporous. While some pores or porosity may be incorporated within the particles as discontinuities or as microporosity, nonporous particles are those particles having a pore volume that is less than 0.1 cc/g of the material forming the particle. Preferably, nonporous particles have a pore volume that is less than 0.10 cc/g (e.g., 0.05 cc/g), and preferably less than 0.02 cc/g, in some embodiments. Pore volume is determined using methods known in the art based on multipoint nitrogen sorption experiments (Micromeritics ASAP 2400; Micromeritics Instruments Inc., Norcross, GA).

The particles of the present technology have an average particle size of less than 10.5 micrometers. For example, the average particle size of a plurality of particles packed within a column in an embodiment of the present technology can be a value anywhere between 10 micrometers and 1 micrometers (e.g., a value anywhere between 8 micrometers and 1.5 micrometers). In one embodiment, the average particle size of the plurality of particles is 7 micrometers. In another embodiment, the average particle size is 3.5 micrometers. In still yet another embodiment, the average particle size is 1.7 micrometers.

The size (i.e., less than 10 micrometers), shape (i.e., spherical), and surface area (i.e., nonporous, smooth or bumpy convex outer surface) create a form factor useful for affinity capture from a flowing sample. To obtain high throughput and to minimize assay development, the particles of the present technology are used in conjunction with LC systems, such as HPLC and UHPLC systems. These systems operate under high pressures (e.g., typically greater than 3,000 psi, such as, for example, 5,000 psi, 10,000 psi, 12,000 psi, 15,000 psi and so forth). As a result, the particles of the present technology need to be rigid particles, such that the particles retain their form factor under HPLC and UHPLC operating conditions.

In general, the particles of the present technology are rigid particles that maintain their form factors (e.g., are not damaged, crushed, squished, or altered) under HPLC or UHPLC operating conditions (e.g., pressures and flow rates). For example, rigid particles in accordance with the present technology, are not visibly altered in form (e.g., not broken, crushed, or altered from spherical) as can be confirmed using scanning electron microscopy before (i.e., control) and after application of HPLC or UHPLC conditions.

A particular material for forming a core (e.g., center or base) of the particles of the present technology that meets the form factor considerations is polymers, and in particular organic polymers. In an embodiment, the nonporous particles of the present technology include a nonporous polymer core. In one embodiment, the nonporous polymer cores of the particles are divinylbenzene (DVB), for example divinylbenzene 80%. In some embodiments, the nonporous polymer cores are formed to include two or more polymers. For example, in some embodiments the nonporous polymer cores include both divinylbenzene and polystyrene. In certain embodiments, the nonporous polymer cores can be manufactured to include a gradient in the polymer composition. For example, the inner portion of the core can be formed of 100% of first polymer (i.e., polymer A) and an outer portion of the core can be formed of 100% or some percentage greater than 0% of a second polymer (i.e., polymer B). Radially from the inner portion to the outer portion of the core, the percentage of polymer A and polymer B can vary to form the gradient in polymer composition. Other embodiments of nonporous polymer cores and particles suitable for use with the present technology are described in U.S. Patent Publication No. 2019/0322783.

While examples and embodiments of the present technology illustrate the use of nonporous polymer cores for the particles, it is noted that other nonporous materials can be utilized as long as the form factor of the particles can be maintained under the operating conditions of HPLC or UPHLC. That is, other materials, such as silica, metal oxides, hybrid inorganic-organic materials, or combinations thereof may be used to create nonporous spherical particles having an average particle size of less than 10 micrometers and that have the rigidity or strength to retain their form factor under the high operating pressures.

To form particles useful for affinity capture, the outer surface of the nonporous core of the particles is linked or connected to an affinity attachment group. To do so, in one embodiment, the outer surface of the nonporous polymer core contains a hydrophilic material. That is, a hydrophilic surface is created on this outer region of the nonporous polymer core. To the hydrophilic surface, one or more molecules of streptavidin is conjugated to the hydrophilic surface. The one or more molecules of streptavidin provide accessible binding sites for attachment of an affinity group, such as a biotinylated oligonucleotide, a biotinylated antibody or biotinylated antigen-binding fragment thereof. In some embodiments the biotinylated antibody is a polyclonal antibody, monoclonal antibody, nanobody, monobody, single domain antibody, bispecific antibody, or camelid. In some embodiments, the biotinylated antibody may be of an IgG, IgM, IgA, IgE, or IgD isotype. In some embodiments, the biotinylated antibody may be derived from a human, mouse, rabbit, goat, or other species. In some embodiments, the antibody may be a chimeric antibody. In some embodiments, the antibody may be a humanized antibody. In one aspect, any protein-based affinity group that is biotinylated is suitable for use with the present technology.

In one aspect, any nucleic acid-based affinity group that is biotinylated is suitable for use with the present technology. In some embodiments, the affinity group is a biotinylated oligonucleotide. The oligonucleotide may comprise deoxyribonucleic acids (DNA), ribonucleic acids (RNA), or a combination thereof. DNA oligonucleotides comprise the nucleotides cytidine, guanosine, adenosine, and thymidine. RNA oligonucleotides comprise the nucleotides cytidine, guanosine, adenosine, and uridine. In some embodiments, the oligonucleotide may comprise nucleic acid analogues (i.e., non-naturally occurring nucleic acids or analogues thereof). Examples of nucleic acid analogues include peptide nucleic acids, locked nucleic acids, glycol nucleic acids, threose nucleic acids, hexitol nucleic acids. Nucleic acid analogues are further reviewed in Wang et al., Molecules (2023) 28 (20): 7043. Oligonucleotides may further be modified at the nucleobase, sugar, or phosphodiester backbone with an array of chemical modifications which are further reviewed in Epple et al., Emerg. Top. Life. Sci. (2021) 5 (5): 691-697. Methods of biotinylating oligonucleotides, including modified oligonucleotides or oligonucleotides comprising non-naturally occurring nucleic acid analogues, are well known in the art and would be readily understood by a person of ordinary skill.

The hydrophilic surface can also be referred to as a hydrophilic layer. The hydrophilic surface is located on the outer surface of the nonporous polymer core and can be formed of a polymer, molecule or siloxane that has a high density of hydrophilic groups (e.g., hydroxyls, PEG, sugars or carbohydrates). The immobilization of these hydrophilic groups can occur by condensation (ester, amid, silanol, sily ether), polymerization (methacrylates, acrylates, styryl) epoxy activation (epihydrochlorin), or ether formation (direct attachment of PEG or carbohydrate groups by ether formation).

In one embodiment, the hydrophilic surface comprises a material selected from the group consisting of: (3-glycidyloxypropyl) trimethoxysilane, (3-glycidyloxypropyl)triethoxysilane, polyacrylate, poly(methyl acrylate), and combinations thereof. In another embodiment, the hydrophilic surface comprises a material selected from the group consisting of: glycidol, glyceroltriglycidyl ether, and combinations thereof.

In embodiments in which streptavidin is used for providing binding sites for affinity groups, a linker is typically used to secure or to conjugate the streptavidin to the hydrophilic surface. Such linkers include, but are not limited to epoxy linkers, hydroxyl linkers, and any other linkers as are known in the art (see Hermanson G, “Bioconjugate Techniques” 3^{rd} Edition, July 2013).

In one aspect, the epoxy linker has a formula:

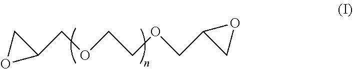

wherein n (the number of ethylene oxide repeating units) is an integer from 1 to 150. In some embodiments, n is 1, 2, 3, 4, 5, 6, 7, 8, 9, 10, 11, or 12. In some embodiments, n is 1, 4, or 9. In some embodiments, n is 1.

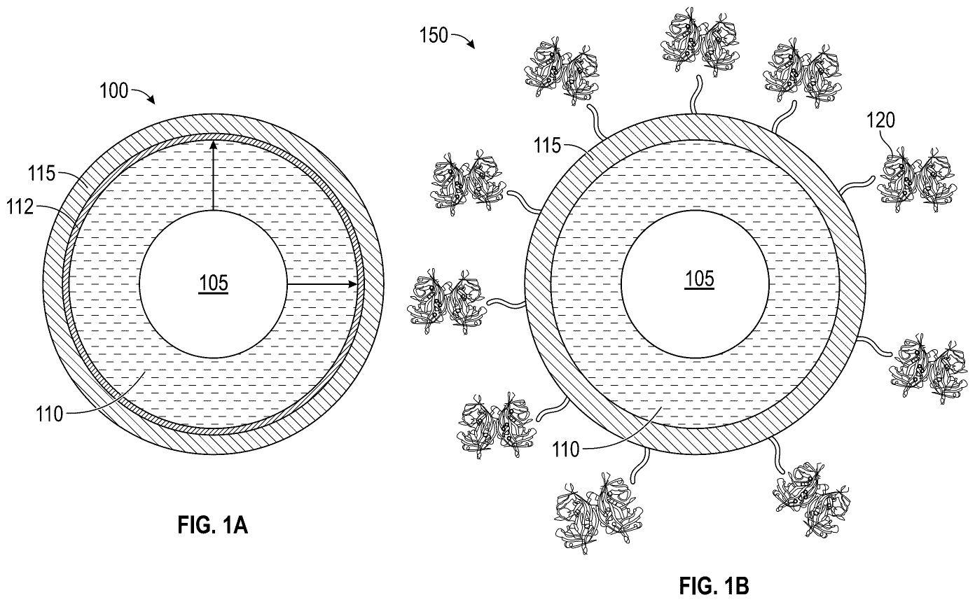

FIG. 1A illustrates an embodiment of a particle having a nonporous polymer core in accordance with the present technology. That is, the particle illustrated in FIG. 1A has a form factor (e.g., spherical, nonporous, and rigid) to withstand operating conditions of HPLC and UHPLC. Particle 100 shown in FIG. 1A is a cross-sectional view prior to the addition of an affinity attachment group, such as for example streptavidin. Particle 100 includes a nonporous polymer core 112 having an inner core region 105 and a radially extending region 110 surrounding the inner core region 105. The inner core region 105 typically is formed of a polymer or a homogenous blend of polymers, whereas the radially extending region 110 typically is formed of two or more polymers to form a gradient within this region. For example, core region 105 can be formed of polystyrene, whereas radially extending region 110 contains a gradient composition transitioning from 100% polystyrene to 80% to 100% DVB with any remainder being polystyrene.

In one embodiment, to form nonporous polymer cores 112, the following three steps were used. In step one: 561.1 g of reagent alcohol (90% ethanol, 5% methanol and ˜5% isopropanol), 16.9 g of polyvinylpyrrolidone (PVP-40, average molecular weight 40,000), 1.6 g of 2,2′-Azobis(2-methylpropionitrile) (AIBN), 6.7 g of Triton™ N-57, 80.1 g of styrene and 2.4 g of poly(propylene glycol) dimethacrylate (average molecular weight 560) were charged into a reactor. After purging with nitrogen, the reaction mixture was heated to 70° C. with stirring and was held at 70° C. until the completion of all the reaction steps. In step two: after the step one reaction mixture was held at 70° C. for 3 hours, a solution containing 52.0 g of DVB 80, 24.0 g of styrene, 51.0 g of PVP-40, 1080.4 g of reagent alcohol (90% ethanol, ^{˜}5% methanol and ^{˜}5% isopropanol) and 54.1 g of p-xylene was added to the reaction mixture at a constant flow rate over two hours. In step three: after the completion of solution charge in step two, a primer coating solution containing 31.2 g of glycidyl methacrylate (GMA), 6.2 g of ethylene glycol dimethacrylate (EDMA), 12.9 g of PVP-40 and 381.9 g of reagent alcohol (90% ethanol, 5% methanol and ^{˜}5% isopropanol) was added to the reaction mixture at a constant flow rate over 1.5 hours. After the reaction mixture was held at 70° C. for a total of 20 hours, the particles were separated from the reaction slurry by filtration. The particles were then washed with methanol, followed by tetrahydrofuran (THF), and followed by acetone. The final product was dried in vacuum oven at 45° C. overnight. 91.8 g of monodisperse 2.3 μm polymer particles were obtained.

While the embodiment shown in FIG. 1A illustrates that the nonporous polymer core 112 has two regions (the inner core region 105 and the radially extending region 110), that need not be the case. Other embodiments may feature a nonporous polymer core having a singular region, i.e., the nonporous polymer core extends from the center of the particle to an outer surface of the nonporous polymer core 112.

As illustrated in FIG. 1A, a hydrophilic surface or layer 115 is formed on an outer surface (i.e., opposite to the center region 105) of the nonporous polymer core. In one embodiment, the hydrophilic surface 115 is formed through the application of a hydrophilic primer coating solution containing 36.2 g of glycidyl methacrylate (GMA), 7.44 g of ethylene glycol dimethacrylate (EDMA), 8.21 g of PVP360 (PVP360, average molecular weight 360,000) and 489.4 g of reagent alcohol (90% ethanol, ^{˜}5% methanol and ^{˜}5% isopropanol). This solution was added into to a mixture containing the nonporous polymer cores at a constant flow rate over about 1.5 hours to form hydrophilic surface 115.

The above example is provided for illustration purposes only. Other types of hydrophilic surfaces can be applied. For example the hydrophilic layer may also be formed of (3-glycidyloxypropyl) trimethoxysilane, (3-glycidyloxypropyl)triethoxysilane, polyacrylate, and/or poly(methyl acrylate), glycidol, glyceroltriglycidyl ether, or any other type of hydrophilic material.

To attach the affinity attachment group, i.e., the streptavidin, a linker is used to conjugate the hydrophilic surface 115 to the affinity attachment group. Referring to FIG. 1B, shown is a particle 150 after conjugation. That is, particle 150 is the result of conjugating the affinity attachment group 120 to the hydrophilic surface 115 through use of the linker. As described above any type of linker can be used. One of ordinary skill in the art would understand there are various ways to attach the streptavidin molecule to the hydrophilic layer. A number of methods for conjugation are suitable for use with the present technology. For example, an epoxy linker can be used to join the affinity attachment group (i.e., streptavidin) to the hydrophilic group 115.

The affinity attachment group provides accessible binding sites for a future biotinylated affinity group. For example, the particles shown in FIG. 1B can be provided with an affinity group prior to or after packing within a chromatographic device. In one embodiment, the affinity attachment group is streptavidin. In another embodiment, the affinity attachment group is avidin. In some embodiments, the affinity attachment group is a protein that binds to biotin.

Streptavidin naturally occurs as a homo-tetramer with four available binding pockets for biotin. Due to the stochastic nature of how streptavidin is conjugated to the nonporous particle, a given streptavidin molecule may have 0, 1, 2, 3, or 4 accessible binding sites. In some embodiments, the biotinylated affinity agent may bind to 0, 1, 2, 3, or 4 accessible binding sites of a given streptavidin molecule. In some embodiments, the biotinylated antibodies or biotinylated antigen-binding fragments thereof may bind to 0, 1, 2, 3, or 4 accessible binding sites of a given streptavidin molecule. In some embodiments, the biotinylated oligonucleotide may bind to 0, 1, 2, 3, or 4 accessible binding sites of a given streptavidin molecule. In some embodiments, a portion of the plurality of the accessible streptavidin binding sites are occupied by a biotinylated oligonucleotide or a biotinylated antibody or antigen-binding fragment thereof. In some embodiments, 50-55%, 55-60%, 60-65%, 65-70%, 70-75%, or more than 75% of the plurality of the accessible streptavidin binding sites are occupied by a biotinylated oligonucleotide, or a biotinylated antibody or biotinylated antigen-binding fragment thereof. The extremely strong affinity between biotin and streptavidin ensures that the biotinylated affinity agents are immobilized onto the solid phase of the chromatography column. The interaction between biotin and streptavidin is resistant to organic solvents, changes in pH, changes in temperature, detergents, and many concentrations of denaturants. As such, the affinity chromatographic columns disclosed herein are suitable for use with a range of organic solvents, pH, temperatures, and samples.

In one aspect, the nonporous particles are conjugated to one or more molecules of streptavidin. In some embodiments, the streptavidin molecules are present at 1-6 μg/mg of particle. In some embodiments, the streptavidin molecules are present at 1-2, 2-3, 3-4, 4-5 or 5-6 μg/mg of particle. In some embodiments, the nonporous particles are conjugated to avidin. In some embodiments, the nonporous particles are conjugated to a protein that binds to biotin. One of ordinary skill in the art would understand that the use of avidin or streptavidin would achieve similar results. The nonporous particles conjugated to streptavidin are then suitable for use in preparing affinity chromatographic columns with any biotinylated affinity agent, such as for example, biotinylated oligonucleotide, biotinylated antibody, or biotinylated antigen-binding fragment thereof.

As used herein, the term “biotinylated affinity agent” refers to a biotinylated molecule that can specifically bind to a target antigen or complementary nucleic acid sequence. The biotinylated affinity agent may be a biotinylated antibody or antigen-binding fragment thereof or a biotinylated oligonucleotide. The preparation of biotinylated molecules is a process well known and understood in the art. In some embodiments, the molecule is biotinylated with a biotin derivative, including but not limited to iminobiotin, desthiobiotin, disulfide biotin azide, disulfide biotin alkyne or other biotin derivatives.

### Columns and Devices

In the present technology, the materials described above are typically packed into a chromatographic device, such as, for example a chromatographic column. The chromatographic device includes a column body formed of a metal or a metal alloy, e.g., titanium, stainless steel. The column body houses a plurality of the particles, such as a plurality of the particle shown in FIG. 1B.

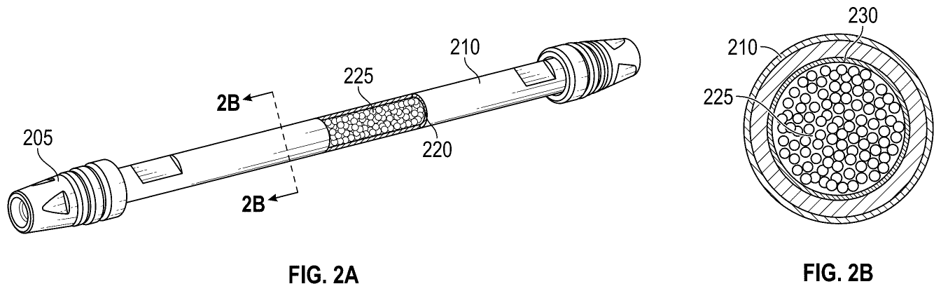

Referring to FIG. 2A, a chromatographic column 205 is shown. This chromatographic column 205 has a stainless steel column body 210. A portion 220 of the column body is removed in FIG. 2A to illustrate the location of a plurality of particles 225. FIG. 2B provides a cross-sectional view of the chromatographic column 205 taken along line B-B in FIG. 2A.

The cross-sectional view of FIG. 2B illustrates the position of the column body 210 surrounding and housing the plurality of particles 225. In some embodiments, an alkylsilyl coating or other high performance surface is provided to limit or reduce non-specific binding of a sample with the walls or interior surfaces 230 of the column body 210. Without wishing to be bound by theory, it is believed that an alkylsilyl coating covering metal surfaces prevent or minimize contact between fluids passing through the column body 210 and the interior surfaces 230. The alkylsilyl coating can be applied to the interior surfaces 230 of the metal column body 210 defining what is known as a wetted path of the column. A metal wetted path includes all surfaces formed from metal that are exposed to fluids during operation of the chromatographic column. The metal wetted path includes not only the column body walls but also metal frits disposed within the column. In embodiments, the alkylsilyl coating is applied not only to the walls of the column body 210, but also to the frits.

In general, the alkylsilyl coating is applied through a vapor deposition technique. Vaporized precursors are charged into a reactor in which the part to be coated is located. These vaporized precursors react on the surfaces of the part to be coated to form a first layer of deposited material. The vapor deposition can be applied in a stepwise function to apply a number of layers of deposited material to the surfaces to grow a thickness of the coating and/or to apply layers of different materials (e.g., alternating between a first and second material) to form the coating.

In some embodiments, the alkylsilyl coating is applied to other portions of the liquid chromatography system. For example, the alkylsilyl coating can be applied to metal components residing upstream and downstream of the column. Specifically, the alkylsilyl coating can be applied to an injector of the liquid chromatography system and to post column tubing and connectors (e.g., tubing and connectors leading from the column to downstream components such as detectors).

In one embodiment, the alkylsilyl coating comprises a hydrophilic, non-ionic layer of polyethylene glycol silane. In another embodiment, the alkylsilyl coating is formed from one or more of the following precursor materials bis(trichlorosilyl) ethane or bis(trimethoxysilyl) ethane. Other embodiments of alkylsilyl coatings suitable for use with the present technology are described in US Patent Publication No. 2019/0086371 and US Application Publication No. 2022/0118443.

The chromatographic device of the present technology can be appropriately sized for use in HPLC systems, UHPLC systems, or in FPLC (fast protein liquid chromatography) systems. For example, in an embodiment in which the plurality of particles packed into the column have an average particle size of 3.5 micrometers or 1.7 micrometers, the column body of the present technology can have an internal diameter between 1 mm to 4.6 mm and a column length of between 5 and 50 cm. In certain embodiment, the column body has an internal diameter of between 1 mm and 2.1 mm and a length between 15 and 50 cm.

### Adding the Affinity Group

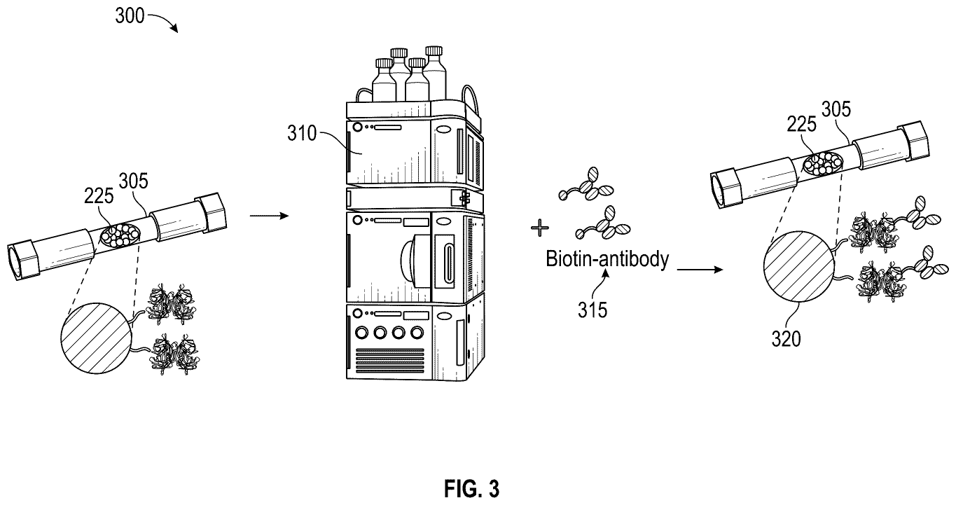

Referring to FIG. 3, a method 300 of adding a biotinylated antibody or biotinylated antigen-binding fragment thereof to the chromatographic device is illustrated. Specifically, method 300 includes providing a streptavidin column 305, which contains the plurality of particles 225 described above and in connection with FIGS. 2A and 2B. The streptavidin column 305 is connected or used with a liquid chromatography system 310, such as a HPLC system or UHPLC system (e.g., the ACQUITY™ Premier UPLC™ systems available from Waters Technologies Corporation (Milford, MA)). A container or vial of a solution containing the biotinylated antibody or biotinylated antigen-binding fragment 315 is connected to the liquid chromatography system such that the solution can be injected into the column using the LC system's fluidic controls. As a result of the controlled injection, the biotin-antibody or biotin antigen-binding fragment 315 bonds to the accessible binding sites of the streptavidin located on the outer surface of the particles within the plurality of particles 225 to form particles 320 for affinity capture.

In general, the biotinylated antibody or biotinylated antigen-binding fragment thereof is coupled to the streptavidin 120 residing on the particles 225 by flowing a solution of molecules (i.e., biotinylated affinity agent) across the plurality of particles 225 that are housed in a column. This can be achieved in a constant flow method, a flow-then static hold-then flow method, or static only method. An advantage of flow or static hold is allowing time for complete binding interactions. An advantage of solution pumped across a bed of particles (i.e., plurality of particles 225) packed into a device include precise metering of reagents, contact times and ability to use post column detectors (e.g., use of detector to monitor amount of biotinylated molecule eluting from column versus loading on the column).

The pump system used to pump fluids across the plurality of particles 225 in the chromatographic devices include UHPLC system pumps, HPLC system pumps, and FPLC system pumps. These pump-column systems can be connected to a post-column detector (UV, TUV, PDA, RI, MALS, MS, FL) or they can flow without attachment to a detector. Multiple columns can be coupled in series or in parallel using tubing to increase throughput. The effluent of the columns can be isolated and reused or directed to suitable waste container.

After flowing the solution of molecules (i.e., biotinylated affinity agent) through the plurality of particles 225, the chromatographic device can be washed with water, PBS buffer or storage buffer, and then stoppered or enclosed to prevent evaporation and, if desired, stored in a refrigerator until ready for use.

In some embodiments, a column packed with a plurality of particles 225 can be washed with water, a buffer or storage solution, and/or an acetonitrile-based solution (e.g., 20% acetonitrile and 1% phosphoric acid) prior to adding the solution containing biotinylated affinity agent. The column packed with the plurality of particles 225 can be stored prior to the loading of the biotinylated affinity agent.

In an alternative method, the biotinylated group can be coupled to the streptavidin 120 linked to the hydrophilic surface 115 of the plurality of particles 225 in a batch reactor, such as a stirred or unstirred reactor, beaker, or flask. Isolation and washing of the product can be achieved by centrifugation or filtration. The resulting materials (i.e., plurality of particles with attached affinity group) can be combined with a storage buffer and stored in a suitable container (possibly with refrigeration) until ready for use.

Following coupling of the biotinylated affinity group to the plurality of particles, it may be advantageous to endcap the plurality of particles with excess biotin. This process, referred to herein as ‘biotin endcapping’ involves the addition of free biotin to the plurality of particles after a biotinylated affinity group is added. The free biotin can interact with remaining, unoccupied binding sites on the streptavidin molecules, increasing efficiency and reducing noise. Said unoccupied streptavidin binding sites may be present due to, for example, incomplete saturation of the column or due to steric hindrance that blocks the biotin of the affinity group from binding to streptavidin. Example 9 describes a method of biotin endcapping.

A number of affinity groups are suitable for use in the disclosed technology, provided that the affinity groups are biotinylated. In some embodiments, the affinity group is a biotinylated antibody or biotinylated antigen-binding fragment thereof. In some embodiments, the affinity group is a biotinylated anti-insulin antibody. In some embodiments, the affinity group is a biotinylated anti-AAV9 antibody. In some embodiments, the affinity group is a biotinylated anti-AAV2 antibody. In some embodiments, the affinity group is a biotinylated anti-AAV capsid antibody, wherein the anti-AAV capsid antibody has affinity to different AAV serotypes, including AAV1, AAV2, AAV3, AAV4, AAV5, AAV6, AAV7, AAV8, and AAV9. In some embodiments, the affinity group is a biotinylated anti-PFAS (perfluoroalkyl substance) antibody. In some embodiments, the affinity group is a biotinylated anti-IgG antibody. In some embodiments, the affinity group is a biotinylated polyclonal antibody (or a population of biotinylated polyclonal antibodies) that bind to host cell proteins (a biotinylated anti-HCP antibody). In some embodiments, the affinity group is a biotinylated anti-double stranded RNA (anti-dsRNA) antibody.

As used herein, the term “host cell protein” refers to process-related proteinaccous impurities present in a host cell culture or host cell line. Thus, a host cell protein may be any protein present in a host cell culture or a host cell line.

In yet other embodiments, the affinity group is a biotinylated oligonucleotide (or oligomer, used interchangeably herein). The oligonucleotide can be biotinylated on either the 5′ or 3′ end. The oligonucleotide can range from 5-50 nucleotides. In some embodiments, the oligonucleotide comprises 25 nucleotides. Any or all of the nucleotides in the oligonucleotide can further be modified using methods known in the art. The oligonucleotide may comprise deoxyribonucleic acids (DNA), ribonucleic acids (RNA), or a combination thereof.

Biotinylated oligonucleotides suitable for use in the present technology generally follow the formula:

B₀₋₁(Xₙ)ₚB′₀₋₁ (Formula II)
wherein B and B′ are independently a biotin group, provided that at least one of B or B′ is present;
X is independently a nucleotide, nucleoside, or derivative thereof, including but not limited to adenosine, thymidine, guanosine, and cytidine;
n is independently 1-50; and
p is independently 1-50.

In some embodiments of the above formula, B is 1, X is thymidine, n is 25, p is 1, and B′ is 0. The resultant 5′ biotinylated oligonucleotide comprises 25 thymidine units (i.e., a 25-mer of thymidine or dT₂₅).

In some embodiments, the affinity group is a biotinylated oligonucleotide of Formula II. In some embodiments, the biotinylated oligonucleotide sequence is complementary to a target analyte sequence.

Antibodies suitable for use with the disclosed technology can be generated by any method known in the art. For example, antibodies can be generated using hybridoma technology. Oligonucleotides suitable for use with the disclosed technology can be generated by any methods known in the art. For example, oligonucleotides can be synthesized using solid-phase synthesis. Oligonucleotides, antibodies or antigen-binding fragments thereof can be biotinylated by any means known in the art. For example, the antibody or antigen-binding fragment thereof can be biotinylated using commercially available kits, conjugation methods, or enzymatic methods.

### METHODS AND EXAMPLES

### Example 1: Addition of Epoxy Linker to Hydrophilic Particles

The nonporous, epoxy-modified hydrophilic particles for use in the disclosed methods were prepared as follows. As a first step, 1500 g of reagent alcohol (90% ethanol, ˜5% methanol, and ˜5% isopropanol), 45.1 g of polyvinylpyrrolidone (PVP-40), 4.8 g of 2,2′-Azobis(2-methylpropionitrile), 5.9 g of Triton™ N-57, 81.7 g of styrene were charged into a reactor. After the reactor was purged with nitrogen gas, the reaction mixture was heated to and maintained at 70° C. with stirring for 3 hours.

After three hours, a solution containing 110.4 g of divinylbenzene 80 (DVB), 39.7 g of PVP-40, 510 g of reagent alcohol, and 100.2 g of p-xylene was added to the reaction mixture at a constant flow rate over two hours. Following this step, a primer coating solution containing 26.0 g of glycidyl methacrylate (GMA), 26.0 g of ethylene glycol dimethacrylate (EDMA), 36.4 g of PVP-40, and 560 g of reagent alcohol were added to the reaction mixture at a constant flow rate over 1.5 hours.

The reaction mixture was maintained at 70° C. for a total of 20 hours, after which the particles were separated from the reaction slurry by filtration. The particles were then washed sequentially with methanol, tetrahydrofuran (THF), and acetone. The final product was dried in a vacuum oven at 45° C., resulting in monodisperse 3.5 μm polymer particles. These particles contain a gradient polystyrene/DVB core with a poly(GMA/EDMA) primer. While the above reaction conditions generate 3.5 μm polymer particles, it is understood that particles ranging in sizes from 1.0 μm to 10 μm (e.g., 1.5 μm to 8 μm, such as 3.5 μm) are within the scope of the disclosure. By altering the concentrations of PVP-40, 2,2′-Azobis(2-methylpropionitrile), and Triton N-57, one of ordinary skill in the art could generate a range of particle sizes.

The resultant 3.5 μm, polystyrene/DVB particles with the poly(GMA/EDMA) primer were then coated with a hydrophilic layer. 70 g of the particles were hydrolyzed in 0.5M H₂SO₄ at 60° C. for 1-20 hours. The hydrolyzed particles were washed sequentially with MilliQ water and methanol, and then dried under vacuum at 45° C. overnight. The dried particles were added into a 1 L three-necked round bottom flask with an overhead stirring motor, stirring shaft, and stir blade, a water cooled condenser, a nitrogen inlet, and a probe-controlled heating mantle. 700 mL of anhydrous diglyme (diethylene glycol dimethyl ether) was added, the flask sealed, and purged with nitrogen for 15 minutes with moderate stirring. 2.0 g of potassium tert-butoxide was added, and the reaction was raised to 70° C. To generate the hydrophilic layer, a mixture of 10.5 g glycidol, 2.6 g of glyceroltriglycidyl ether, and 14.9 g of anhydrous diglyme was prepared separately and added to the particle mixture in four equal aliquots in 30 minute intervals. The reaction was held at 70° C. for 20 hours, cooled to RT, and filtered. The resulting particles were washed sequentially with water 6 times, methanol 3 times, and then dried under vacuum overnight at 45° C. The following procedure results in a hydrophilic layer that is 2-4% (by weight) of the entire particle.

20 g of the resultant 3.5 μm particles with the hydrophilic coating were added to a mixture of 100 g of ethylene glycol diglycidyl ether (EGDGE) and 100 g of MeOH at room temperature. 1 mL of 50% sodium hydroxide in water was added and the reaction was stirred continuously for 20 h. The particles were isolated by filtration, washed with 40 mL of MeOH ten times, and partially dried under nitrogen flow. The particles were stored for later use in a methanol wet bed at 4° C. The resultant particles have sufficient epoxide content to enable functionalization of the particle surface.

Alternatively, 20 g of the resultant 3.5 μm particles with the hydrophilic coating were added to a mixture of 100 g of poly(ethylene glycol) diglycidyl ether (a compound of Formula 1, wherein n is 4, also known as PEGDE 200) and 100 g of MeOH at room temperature. 1 mL of 50% sodium hydroxide in water was added and the reaction was stirred continuously for 20 h. The particles were isolated by filtration, washed with 40 mL of MeOH ten times, and partially dried under nitrogen flow. The particles were stored for later use in a methanol wet bed at 4° C. The resultant particles have sufficient epoxide content to enable 3.3 μg streptavidin coverage per mg particle.

Alternatively, 20 g of the resultant 3.5 μm particles with the hydrophilic coating were added to a mixture of 100 g of poly(ethylene glycol) diglycidyl ether (a compound of Formula 1, wherein n is 9, also known as PEGDE 400) and 100 g of MeOH at room temperature. 1 mL of 50% sodium hydroxide in water was added and the reaction was stirred continuously for 20 h. The particles were isolated by filtration, washed with 40 mL of MeOH ten times, and partially dried under nitrogen flow. The particles were stored for later use in a methanol wet bed at 4° C. The resultant particles have sufficient epoxide content to enable 3.4 μg streptavidin coverage per mg particle.

### Example 2: Streptavidin Functionalized Particles

Particles were prepared as described in Example 1 and functionalized with streptavidin. 1.5 g of particles were mixed in 7 mL of a 50-100 mM buffer (pH 8-9.2). To this, 1.5 mL of a 10 mg/mL solution of streptavidin (15 mg) was added. Next, 21.4 mL of a buffer containing a salting out agent was added dropwise. The reaction was then stirred for 20 hours between 24-37° C. The buffer system, salting out agent and its concentration together with the temperature of the reaction can be adjusted to manipulate the extent of streptavidin coverage on a given particle, as shown in Table 1.

Following the 20 h incubation, 1 g of ethanolamine in 4 mL of a buffer solution (e.g., sodium phosphate) was added and the reaction stirred at RT for 3 hours. Particles were then isolated by filtration and washed. The washing process comprises: step 1: three times pH4 water (i.e., adjusted with HCl); step 2: three times with water or water/organic solvent mixture as described in Table 1; step 3: three times with water; and step 4: twice with storage buffer (100 mM PBS, PH 7.3, 0.02% sodium azide). The particles were stored in a sealed container as a slurry in storage buffer (˜10 mL buffer/g of particle) at 4° C. Streptavidin coverage of the particles was determined using a standard bicinchoninic acid assay (BCA). Maximum binding capacity was estimated using the ratio of the molecular weight of streptavidin and a biotinylated antibody multiplied by the binding valency of streptavidin (4) as shown in Table 1.

TABLE 1
Particles Functionalized with Streptavidin

| | | | | | Streptavidin | Maximum Binding |
|---|---|---|---|---|---|---|
| | | | | Particle | Coverage | Capacity |
| Product | Buffer | Salting | | Wash 2^{nd} | (μg/mg | (μg IgG/mg |
| # | System | Out Agent | Temp | Step | particle) | particle) |
| 2a | Phosphate | 1.7M | 24° C. | Water | 2.2 | 24 |
| | Buffer | Ammonium | | | | |
| | (pH 8) | Sulfate | | | | |
| 2b | Phosphate | 2.85M | 24° C. | Water | 3.3 | 36 |
| | Buffer | Ammonium | | | | |
| | (pH 8) | Sulfate | | | | |
| 2c | Phosphate | 2.85M | 37° C. | Water | 4.6 | 50 |
| | Buffer | Ammonium | | | | |
| | (pH 8) | Sulfate | | | | |
| 2d | Phosphate | 2.85M | 37° C. | Acetonitrile/ | 5.2 | 57 |
| | Buffer | Ammonium | | Water (1/3) | | |
| | (pH 8) | Sulfate | | | | |
| 2e | Phosphate | 2.85M | 37° C. | Dimethyl | 4.6 | 50 |
| | Buffer | Ammonium | | sulfoxide/ | | |
| | (pH 8) | Sulfate | | Water (1/9) | | |
| 2f | Carbonate- | 1.5M | 37° C. | Water | 3.9 | 43 |
| | bicarbonate | Sodium | | | | |
| | Buffer | Sulfate | | | | |
| | (pH 9.2) | | | | | |
| 2g | Carbonate- | 1.5M | 37° C. | Dimethyl | 4.0 | 44 |
| | bicarbonate | Sodium | | sulfoxide/ | | |
| | Buffer | Sulfate | | Water (1/9) | | |
| | (pH 9.2) | | | | | |
| 2h | Carbonate- | 1.5M | 24° C. | Dimethyl | 3.4 | 37 |
| | bicarbonate | Sodium | | sulfoxide/ | | |
| | Buffer | Sulfate | | Water (1/9) | | |
| | (pH 9.2) | | | | | |

### Example 3: Preparation of an Anti-Insulin Affinity Chromatographic Column

Particles prepared as described in Example 2 using 2.85M ammonium sulfate at 24° C. (product #2b) were packed in a 2.1×20 mm column hardware and stored in storage buffer (100 mM PBS, pH 7.3, 0.02% sodium azide; at ˜10 mL/g particle). The column was stored at 4° C. until ready for use. The column was connected to a liquid chromatography instrument and purged with 100 mM sodium phosphate buffer (pH 7.4) at 0.1 mL/min. Next, a 5 μL injection of a 0.5 mg/mL solution of biotinylated anti-insulin antibody was injected onto the column and flowed for 0.1 mL/min for 2 mins. These injections were repeated and the effluent was monitored across 140 injections using a UV detector (280 nm). The UV detector allows for the measurement of the percentage of antibody eluted.

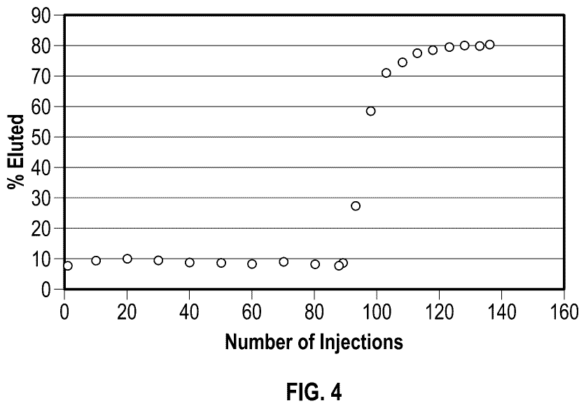

It was shown that the biotinylated, anti-insulin antibody was binding to the streptavidin-functionalized beads of the column as indicated by the low level of antibody eluting from the column during the initial injections. After ˜90 injections, the amount of biotinylated antibody in the effluent increased, indicating that excess biotinylated antibody was not binding to the column and that the streptavidin sites were saturated (FIG. 4). Based on these results, it was estimated that ˜300 μg of the biotinylated antibody was bound to the column device. The column was washed with phosphate buffer and then storage buffer.

### Example 4: Preparation of an Anti-AAV Affinity Chromatographic Column

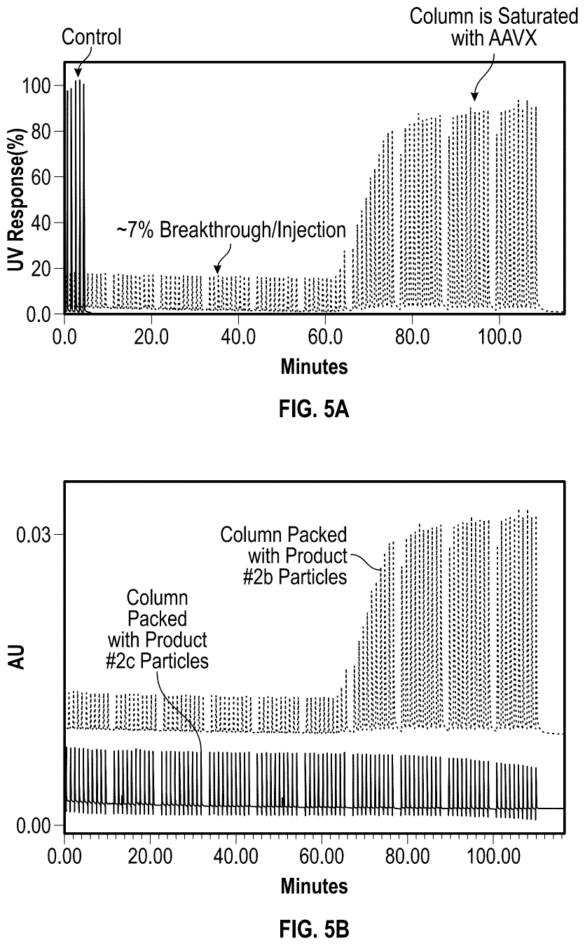

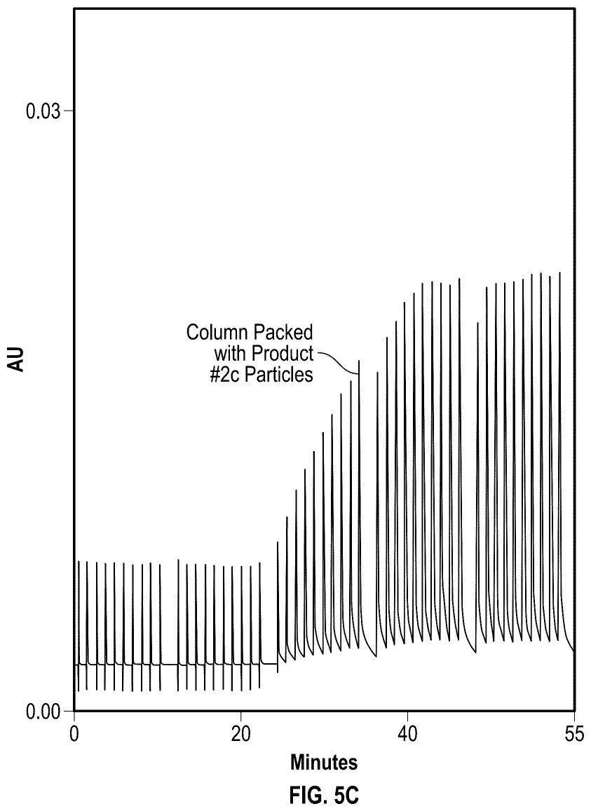

A column of particles functionalized with streptavidin was prepared as described in Example 2 (i.e., product #2b). The column was then equilibrated in 0.1M phosphate buffer (pH 7.5) on a liquid chromatography device at 25° C. with a flow rate of 0.1 mL/min. A 1.5 μL injection of a 1 mg/mL solution of biotinylated anti-AAV monobody was injected onto the column. This process was repeated with 100 injections, representing a 150 μg total mass load. Effluent was monitored using a UV detector (280 nm). As a control, 5 injections were analyzed by the UV detector via PEEK union, bypassing the column itself, representing 100% expected signal for unretained AAVX (FIG. 5A).

It was shown that biotinylated anti-AAV monobody was binding to the streptavidin-functionalized beads of the column as indicated by the low level of antibody eluting from the column during the initial injections. After ˜70 injections (105 μg of anti-AAV antibody), the amount of biotinylated antibody in the effluent increased, indicating that excess biotinylated antibody was not binding to the column and that the streptavidin sites were saturated (FIG. 5A).

To increase the amount of antibody bound to the functionalized particles, a column packed with particles having a greater surface coverage of streptavidin was investigated. That is, a column was packed with particles prepared as described in Example 2, product #2c, which has about twice the maximum binding capacity as product #2b. The solution of biotinylated anti-AAV monobody was injected using the same process as was used for the column containing product #2b particles as shown in FIG. 5B. The column packed with particles of product #2c did not show breakthrough until the experiment was re-started after 100 injections as demonstrated in FIG. 5C (which provides a chromatogram of additional injections following the first 100 injections from FIG. 5B). This column was loaded with AAVX nanobody after approximately 140 injections, providing about 2× amount of immobilized AAVX on the stationary phase of the column packed with product #2c versus the column packed with product #2b.

### Example 5: Preparation of an Anti-Poly(A) Affinity Chromatographic Column

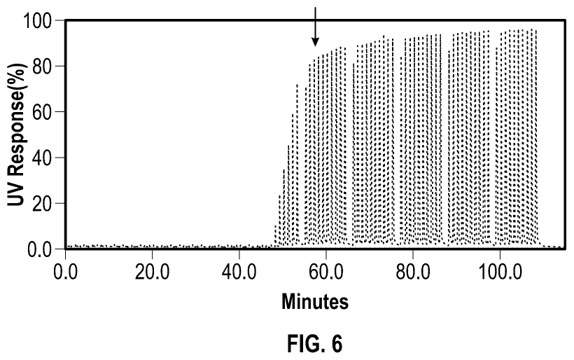

A column of particles functionalized with streptavidin was prepared as described in Example 3. The column was then equilibrated in 0.1M phosphate buffer (pH 7.5) on a liquid chromatography device at 25° C. with a flow rate of 0.1 mL/min. A 2 μL injection of a 0.114 nmol/μL solution of a 5′-biotinylated dT₂₅ oligonucleotide was flowed onto the column. This process was repeated for a total of 100 injections. Effluent was monitored using a UV detector (260 nm) and the signal normalized to 5 control injections via PEEK union, bypassing the column itself, representing 100% expected signal for unretained dT₂₅ oligonucleotide (FIG. 6). The column reached saturation after approximately 50 injections (indicated by arrow), which corresponds to approximately 11.4 nmol of dT₂₅.

### Example 6: Streptavidin Leaching Evaluation Method I

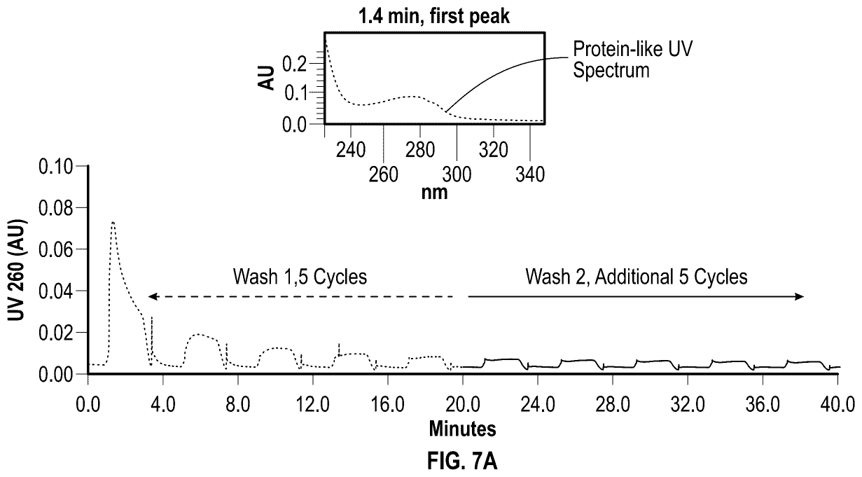

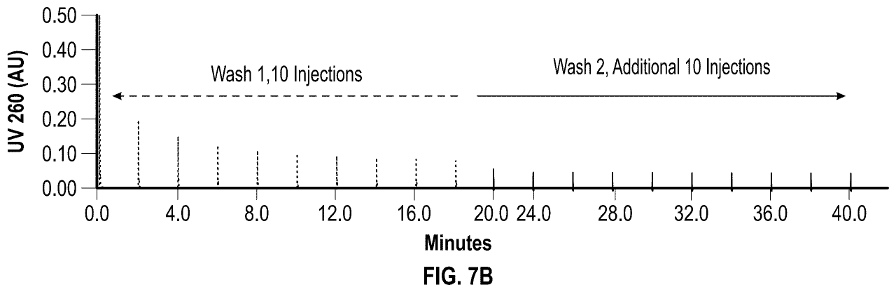

Particles (Example 2, product #2c) were packed in a 2.1×20 mm column hardware and stored in storage buffer (100 mM PBS, pH 7.3, 0.02% sodium azide; at ˜ 10 mL/g particle). The column was stored at 4° C. until ready for use. The column was connected to a liquid chromatography instrument and equilibrated in running 100 mM sodium phosphate buffer (pH7.4) at 0.4 mL/min. Next, step gradient to 20% acetonitrile with 1% phosphoric acid was applied at 0 min and held till 2 min to wash the column. At 2.01 min the mobile phase switched back to 100 mM sodium phosphate buffer and held till 4 min. This wash cycle was repeated five times (Wash 1 labeled in FIG. 7A). Second wash was applied if needed (Wash 2, dotted line in FIG. 7A). The effluent was monitored using a UV detector (280 nm) (FIG. 7A). The inset UV spectrum in FIG. 7A shows that the leachable peak has typical UV spectra of a protein. The applied washing cycle showed a reduction in leachate.

### Example 7: Streptavidin Leaching Evaluation Method II

Particles (Example 2, product #2c) were packed in a 2.1×20 mm column hardware and stored in storage buffer (100 mM PBS, pH 7.3, 0.02% sodium azide; at ˜ 10 mL/g particle). The column was stored at 4° C. until ready for use. The column was connected to a liquid chromatography instrument and equilibrated in running 100 mM sodium phosphate buffer (pH7.4) at 0.4 mL/min. Next, 10 μL injection of 1% phosphoric acid aqueous solution with 20% acetonitrile was injected onto the column. These injections act as short column wash and dislodge non-covalently adsorbed leachate (streptavidin) as a sharp peak. Ten injections were executed (Wash 1, FIG. 7B). The column was then washed with 5 cycles of 1% phosphoric acid aqueous solution with 20% acetonitrile (Method I, described above), and the additional 10 injections of wash solution was repeated (Wash 2, dotted line in FIG. 7B). The effluent was monitored using a UV detector (280 nm). FIG. 7B shows the streptavidin leaching from the column of the particles of Example 2, product #2c. The Method I is an efficient approach to remove the residual (non-covalently bonded) leachates from the sorbent.

Particles (Example 2, products #2c-2 h) were packed in a 2.1×20 mm column hardware and stored in storage buffer (100 mM PBS, pH 7.3, 0.02% sodium azide; at ˜ 10 mL/g particle). The column was stored at 4° C. until ready for use. The column was connected to a liquid chromatography instrument and equilibrated in running 100 mM sodium phosphate buffer (pH7.4) at 0.4 mL/min. Next, 10 μL injection of 1% phosphoric acid aqueous solution with 20% acetonitrile was injected onto the column and the height of the first (highest) peak was measured at 280 nm (Table 2). The data showed that the change in Step 2 particle washing step and immobilization conditions decreased the height of the first peak of the leaching. It is apparent from FIGS. 7A and 7B that the additional washes performed after sorbent packing can further suppress the leachates to approximately 10-fold lover level.

TABLE 2
The peak height measurements of the columns
tested for streptavidin leaching by Method II

| Product # | 280 nm Max |
|---|---|
| 2c | 0.52 |
| 2d | 0.22 |
| 2e | 0.04 |
| 2f | 0.32 |
| 2g | 0.32 |
| 2h | 0.36 |

### Example 8: Preparation of an Anti-Double Stranded RNA (Anti-dsRNA) Affinity Chromatographic Column

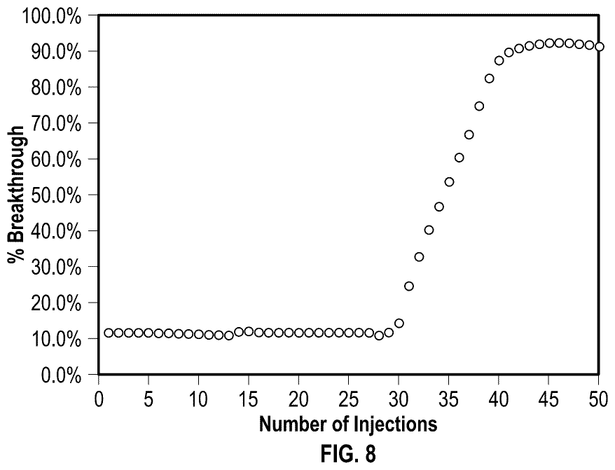

A column of particles functionalized with streptavidin was prepared as described in Example 3. The column was then equilibrated in 100 mM sodium phosphate (pH 7.4) on a liquid chromatography device with a flow rate of 0.1 mL/min. 10 μL injections of 0.73 μg/μL of anti-dsRNA antibody J2 (available from Biotechne) was flowed onto the column. This process was repeated for a total of 50 injections. Effluent was monitored using a UV detector (280 nm). As shown in FIG. 8, the column reached saturation after approximately 40 injections, or about ˜231 μg of biotinylated anti-dsRNA antibody. No leaching was observed after coupling.

### Example 9: Biotin Endcapping of Affinity Chromatographic Columns

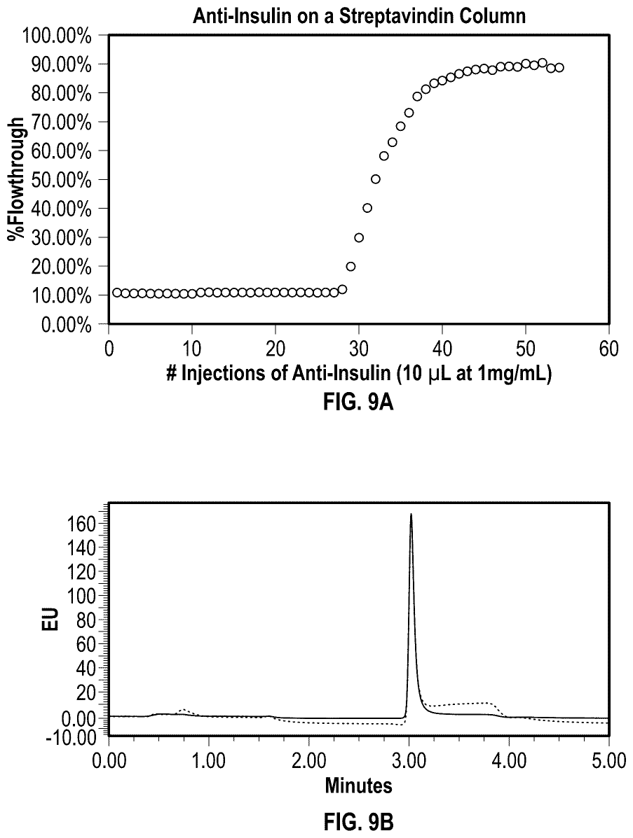

A column of particles functionalized with streptavidin was prepared as described in Example 3. The column was then equilibrated in 100 mM sodium phosphate (pH 7.4) on a liquid chromatography device with a flow rate of 0.1 mL/min. 10 μL injections of 1 mg/mL of anti-insulin antibody was flowed onto the column. This process was repeated for a total of ˜55 injections. Effluent was monitored using a UV detector (280 nm). As shown in FIG. 9A, the column reached saturation after approximately 45 injections, or about ˜400 μg of biotinylated anti-insulin antibody. No leaching was observed after coupling.

The affinity chromatographic column was next used to test the impact of biotin endcapping. 10 μL of a 1 mg/mL insulin sample were injected onto the column using 100 mM Sodium Phosphate (pH 4) at a flow rate of 0.1 mL/min for minutes 0-2 and at a flow rate of 1 mL/min for minutes 2-3. The eluent was monitored using a fluorescence detector at 280 nm excitation and 350 nm emission. The insulin was eluted from the column using 20 mM sodium phosphate (pH 2.3) 500 mM NaCl for minutes 3-4 at 1 mL/min, resulting in the chromatograph represented by the dashed line in FIG. 9B. The column was then equilibrated with 100 mM sodium phosphate (pH 4) for minutes 4-5, after which 4 injections of 1.25 μg biotin were performed (i.e., the affinity chromatography column was endcapped with biotin, wherein the biotin can bind to unoccupied streptavidin binding sites in the column). Said unoccupied streptavidin binding sites may be present due to, for example, incomplete saturation of the column or due to steric hindrance that blocks the biotin of the affinity group from binding to streptavidin. The insulin bind and elute method was repeated, resulting in the chromatograph represented by the solid line in FIG. 9B. The endcapped column resulted in a flatter baseline, which can allow for better quantification, particularly for lower abundance samples. As the endcapping process is independent of affinity group, the biotin endcapping process can be used with any of the affinity chromatographic columns described herein, including but not limited to those described in Examples 4, 5, and 8.

### Example 10: Preparation of an Anti-HCP Affinity Chromatographic Column

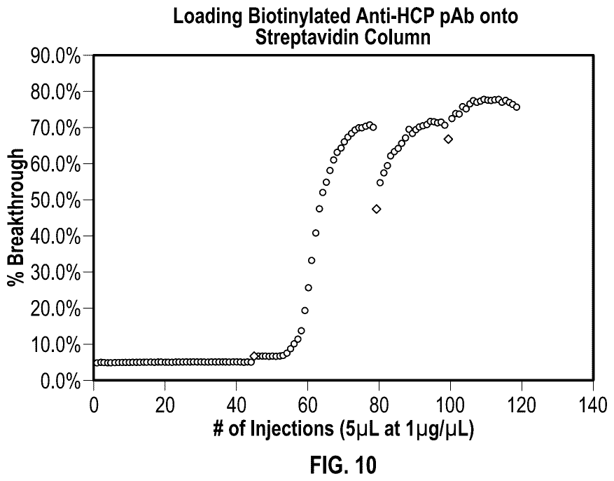

A column of particles functionalized with streptavidin was prepared as described in Example 3. The column was then equilibrated in 1×PBS (pH 7.4). 5 μL injections of 1 ug/uL of biotinylated anti-HCP antibodies were flowed onto the column. This process was repeated for ˜120 injections using a flow rate of 0.1 mL/min. Effluent was monitored using a UV detector (280 nm). As shown in FIG. 10, the column reached saturation between 100-120 injections, or about 300-400 μg of biotinylated anti-HCP antibodies. The diamonds indicate the start of a new vial of anti-HCP antibodies.

### Other Embodiments

While the technology has been described in connection with specific embodiments thereof, it will be understood that it is capable of further modifications and this application is intended to cover any variations, uses, or adaptations of the technology following, in general, the principles of the technology and including such departures from the technology that come within known or customary practice within the art to which the technology pertains and may be applied to the essential features hereinbefore set forth, and follows in the scope of the claims.

Other embodiments are within the claims.

1. A chromatographic column comprising:
a column body formed of a metal or a metal alloy, the column body housing a plurality of particles, each particle of the plurality of particles comprising:
a nonporous polymer core;
a hydrophilic surface on an outer layer of the nonporous polymer core; and
one or more molecules of streptavidin conjugated to the hydrophilic surface, wherein the particle has an average particle size between 1.0 μm to 10 μm.

2. The particle of claim 1, wherein the nonporous polymer core has a gradient composition.

3. The particle of claim 1, wherein the nonporous polymer core comprises divinylbenzene (80%) and polystyrene.

4. The particle of claim 1, wherein the hydrophilic surface is selected from the group consisting of: (3-glycidyloxypropyl) trimethoxysilane, (3-glycidyloxypropyl)triethoxysilane, polyacrylate, glycidol, glyceroltriglycidyl ether, and poly(methyl acrylate).

5. The particle of claim 1, wherein the one or more molecules of streptavidin are conjugated to the hydrophilic surface of the particle via an epoxy linker.

6. The particle of claim 5, wherein the epoxy linker has a formula of: 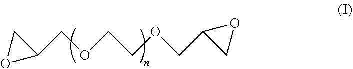
wherein n is between 1-12.

7. The particle of claim 6, wherein n is 1, 4, or 9.

8. The particle of claim 7, wherein n is 1.

9. The particle of claim 1, wherein the average particle size is between 2 μm to 5 μm.

10. The particle of claim 9, where in the average particle size is 3.5 μm.

11. The particle of claim 1, wherein the average particle size between 7 μm to 8 μm.

12. The particle of claim 1, wherein the one or more molecules of streptavidin are bound to a biotinylated oligonucleotide, or a biotinylated antibody or biotinylated antigen-binding fragment thereof.

13. The chromatographic column of claim 1, wherein the one or more molecules of streptavidin conjugated to the hydrophilic surface provides a surface coverage of 2-6 μg/mg particle.

14. The chromatographic column of claim 1, wherein an internal diameter of the column body is between 1 mm to 2.1 mm.

15. The chromatographic column of claim 1, wherein a length of the column body is between 15 to 50 mm.

16. The chromatographic column of claim 1, wherein at least a portion of an interior surface of the column body is coated with an alkylsilyl material.

17. The chromatographic column of claim 16, further comprising frits within the column body, wherein the frits are coated with the alkylsilyl material.

18. The chromatographic column of claim 16, wherein the alkylsilyl material is a hydrophilic, non-ionic layer of polyethylene glycol silane.

19. A chromatographic device comprising:
the chromatographic column of claim 1,
a column injector positioned upstream of the chromatographic column, and tubing in fluidic connection with and located downstream of the chromatographic column,
wherein a portion of an internal surface of the column injector and a portion of an internal surface of the tubing are coated with an alkylsilyl material.
